(19) United States
(12) Patent Application Publication
(10) Pub. No.: US 2017/0351163 A1
(43) Pub. Date: Dec. 7, 2017

(54) SHUTTER DEVICE AND IMAGE-CAPTURING APPARATUS

(71) Applicant: NIKON CORPORATION, Tokyo (JP)

(72) Inventors: Masanori HASUDA, Fujisawa-shi (JP); Kenji OHASHI, Tokyo (JP); Takeshi UEKI, Kawasaki-shi (JP)

(73) Assignee: NIKON CORPORATION, Tokyo (JP)

(21) Appl. No.: 15/521,988

(22) PCT Filed: Oct. 30, 2015
(86) PCT No.: PCT/JP2015/080816

§ 371 Date: Aug. 14, 2017

(30) Foreign Application Priority Data
Oct. 31, 2014 (JP) 2014-223429

(51) Int. Cl. G03B 9/40; G03B 17/12

(52) U.S. Cl. CPC G03B 9/40; G03B 17/12

(57) ABSTRACT

A shutter device includes: a substrate having an opening; a first light-shielding member having a light-shielding region having lengths in first and second directions respectively larger and smaller than those of the opening in the same directions, and partly shields the opening while moving from a first position outside the opening of the substrate to a second position outside the opening, the second position being different from the first position; and a second light-shielding member having a light-shielding region having a length in the first direction smaller than the length of the opening in the first direction and a length in the second direction smaller than the length of the opening in the second direction, and shields the opening between an end in the first direction of the first light-shielding member and the substrate while moving in the second direction.

### TECHNICAL FIELD

The present invention relates to a shutter device and an image-capturing apparatus.

### BACKGROUND ART

So-called normally open type shutter devices having a front curtain light-shielding blade and a rear curtain light-shielding blade are known. In an electronic camera equipped with such a shutter device, a front curtain light-shielding blade is withdrawn from a photographic opening of the shutter device to one side in a direction of movement of light-shielding blades, while a rear curtain light-shielding blade is withdrawn to the other side in order to display a preview image in a photographing preparation state before an actual exposure (see PTL1, for example).

### CITATION LIST

### Patent Literature

PTL1: Japanese Laid-Open Patent Publication No. 2008-164804

### SUMMARY OF INVENTION

### Technical Problem

In the electronic camera equipped with the shutter device described in PTL1, the front curtain light-shielding blade which has been withdrawn from the photographic opening to one side is moved toward the other side to shield the photographic opening, so that a reset operation of the image sensor is performed before the actual exposure. Then, the front curtain light-shielding blade and the rear curtain light-shielding blade are moved toward the one side with a predetermined time difference to expose an image sensor. A release time lag is thus increased.

However, no specific configuration of a shutter device that can further reduce the release time lag has been proposed.

### Solution to Problem

According to the 1st aspect of the present invention, a shutter device comprises: a substrate having an opening; a first light-shielding member that has a light-shielding region having a length in a first direction larger than a length of the opening in the first direction and a length in a second direction smaller than a length of the opening in the second direction, and partly shields the opening while moving from a first position outside the opening of the substrate to a second position outside the opening, the second position being different from the first position; and a second light-shielding member that has a light-shielding region having a length in the first direction smaller than the length of the opening in the first direction and a length in the second direction smaller than the length of the opening in the second direction, and shields the opening between an end in the first direction of the first light-shielding member and the substrate while moving in the second direction.

According to the 2nd aspect of the present invention, it is preferred that in the shutter device according to the 1st aspect, the second light-shielding member is located outside the opening while the first light-shielding member is located in the first position, and the second light-shielding member partly shield the opening in the end in the first direction of the light-shielding region along with the movement of the first light-shielding member in the second direction.

According to the 3rd aspect of the present invention, it is preferred that the shutter device according to the 1st or 2nd aspect further comprises: a first driving member that is provided for the first light-shielding member and drives the first light-shielding member in the second direction, wherein: the second light-shielding member is driven in the second direction by the first driving member.

According to the 4th aspect of the present invention, the shutter device according to any one of the 1st to 3rd aspects may further comprise: a third light-shielding member that moves from the first position in the second direction to shield the opening; and a second driving member that moves the third light-shielding member.

According to the 5th aspect of the present invention, it is preferred that in the shutter device according to the 4th aspect, the end in the first direction of the light-shielding region of the first light-shielding member has a shape that extends around the movement range of the second driving member.

According to the 6th aspect of the present invention, it is preferred that in the shutter device according to any one of the 1st to 5th aspects, the first light-shielding member and the second light-shielding member move to different positions outside the opening of the substrate.

According to the 7th aspect of the present invention, an image-capturing apparatus comprises: the shutter device according to any one of the 1st to 6th aspects; and an image sensor that receives luminous flux from a subject through the shutter device.

### BRIEF DESCRIPTION OF DRAWINGS

FIG. 1 is a view illustrating a configuration of main components of a digital camera according to an embodiment.

FIG. 2 is a view illustrating an internal configuration of a shutter device according to a first embodiment.

FIG. 3 is a view illustrating an internal configuration of the shutter device according to the first embodiment.

FIG. 4 is a view illustrating an internal configuration of the shutter device according to the first embodiment.

FIG. 5 is a view illustrating an internal configuration of the shutter device according to the first embodiment.

FIG. 6 is a view illustrating a light-shielding region of a front curtain light-shielding blade of the shutter device according to the embodiment.

FIG. 7 is a view illustrating an internal configuration of a shutter device according to a second embodiment.

FIG. 8 is a view illustrating an internal configuration of the shutter device according to the second embodiment.

FIG. 9 is a view illustrating an internal configuration of the shutter device according to the second embodiment.

FIG. 10 is a view illustrating an internal configuration of the shutter device according to the second embodiment.

FIG. 11 is a view illustrating an internal configuration of a shutter device according to a third embodiment.

FIG. 12 is a view illustrating an internal configuration of the shutter device according to the third embodiment.

FIG. 13 is a view illustrating an internal configuration of the shutter device according to the third embodiment.

FIG. 14 is a view illustrating an internal configuration of the shutter device according to the third embodiment.

### DESCRIPTION OF EMBODIMENTS

### First Embodiment

An image-capturing apparatus including a shutter device according to an embodiment will be described with reference to the drawings.

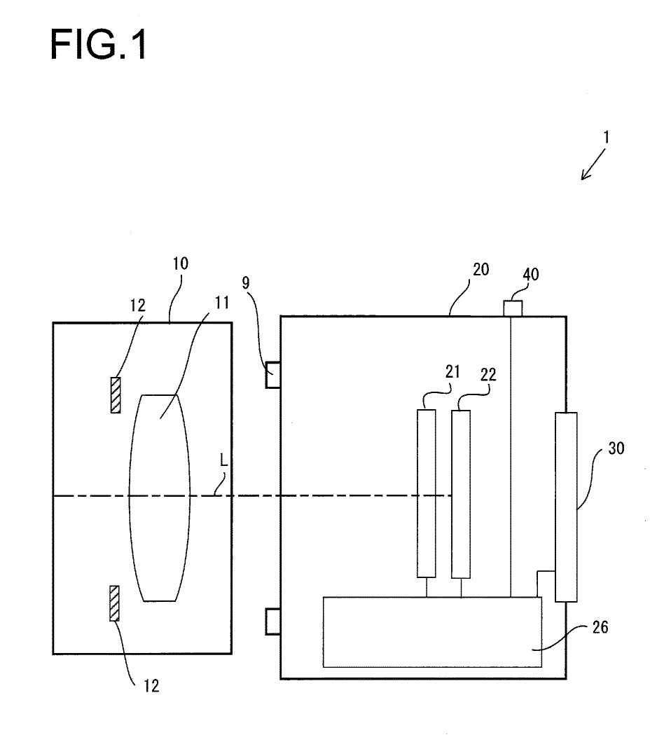

FIG. 1 is a view illustrating a configuration of main components of a digital camera 1 which is an image-capturing apparatus according to an embodiment. As illustrated in FIG. 1, the digital camera 1 is a so-called mirrorless camera including a camera body 20 and a lens barrel 10 that is removably attached to the camera body 20 with a lens mount 9 therebetween. The digital camera 1 may be a single lens reflex camera, instead of a mirrorless camera.

The lens barrel 10 includes an image-forming optical system 11 and a diaphragm 12. The image-forming optical system 11 is an optical system constituted by a plurality of lenses including a focus adjusting lens, for forming a subject image on a predetermined image-forming plane. The focus adjusting lens is moved back and forth in an optical axis L direction by an operation of a lens driving motor (not shown). FIG. 1 schematically illustrates the image-forming optical system 11 as a single lens, for convenience of illustration. The diaphragm 12 limits light flux passing through the image-forming optical system 11, that is, an amount of incident light.

The camera body 20 has a shutter device 21, an image sensor 22, and a controller 26 provided therein. The camera body 20 also has a rear side monitor 30, which includes a display device such as a liquid display, provided on its rear side. The camera body 20 further has an operating unit 40 provided thereon.

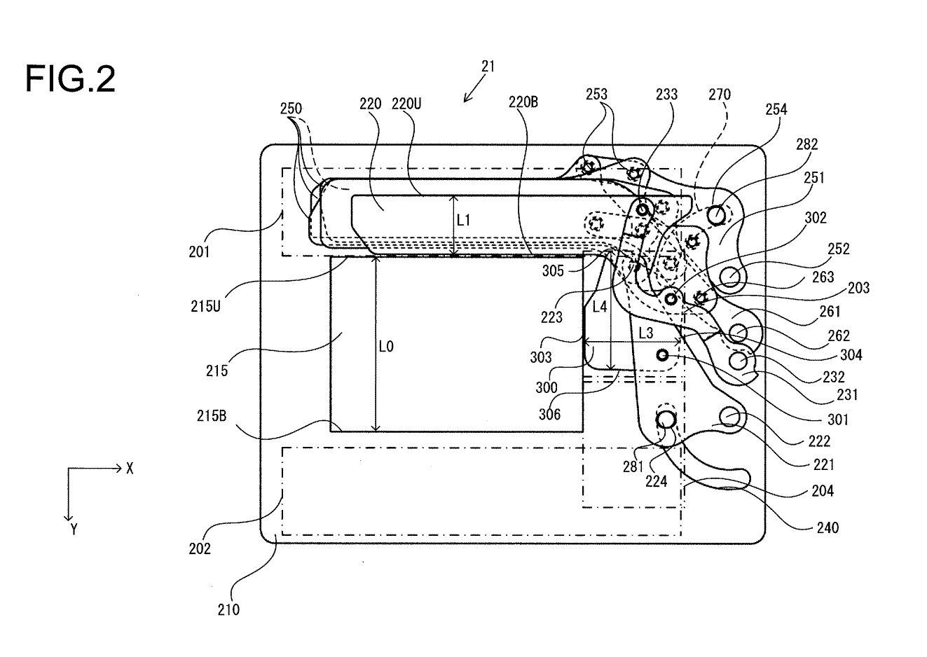

The image sensor 22 is an image sensor having a number of pixels arranged in a matrix, such as a CMOS image sensor. The image sensor 22 is arranged so that its image-capturing plane is positioned on the image-forming plane of the image-forming optical system 11. The image sensor 22 captures the subject image formed on the image-capturing plane by the image-forming optical system 11 through the shutter device 21 and outputs image-capturing signals to the controller 26. Furthermore, various optical filters including an infrared cut filter are provided on the image-capturing plane of the image sensor 22, although not illustrated in FIG. 1. The plurality of pixels constituting the image sensor 22 are two-dimensionally arranged in a pixel row direction (the X axis direction in FIG. 2 described later) and in a pixel column direction (the Y axis direction in FIG. 2 described later) that is orthogonal to the pixel row direction. The pixels are reset and the image-capturing signals are read out for each of pixel rows at different positions in the pixel column direction at different timings.

The shutter device 21 is provided on a front side (a subject side) of the image sensor 22. The shutter device 21 is a so-called focal plane shutter that is driven by a front curtain actuator and a rear curtain actuator (not shown) in accordance with driving signals from a power control unit (not shown) of a controller 26 described later, to shield light flux which would be incident onto the image sensor 22 from the subject. Details of the shutter device 21 will be described later.

The controller 26, which is constituted by a microprocessor, its peripheral circuits, and other circuits, controls components of the digital camera 1 by reading and executing control programs stored in advance in a storage medium (not shown) such as a flash memory. The controller 26 performs various image processing operations on the image-capturing signals output from the image sensor 22 to generate image data of the subject image and record the generated image data in a portable storage medium (not shown) such as a memory card. The controller 26 controls operations of the shutter device 21 and the image sensor 22, as described later. The controller 26 has the power control unit (not shown) that functions to control the operation of the shutter device 21. The controller 26 may be made of electronic circuits having functions equivalent to functions of the control programs.

The operating unit 40 includes various switches allocated to various operating members operated by a user, and outputs operation signals corresponding to operations of the operating members to the controller 26. The operating members include, for example, a release button, a menu button for displaying a menu screen on the rear side monitor 30, a cross key that is operated for selecting various settings and the like, a determination button for determining the settings and the like selected with the cross key, and a mode switching button for switching an operation mode of the digital camera 1 between a photographing mode and a reproduction mode.

Details of the shutter device 21 according to this embodiment will now be described.

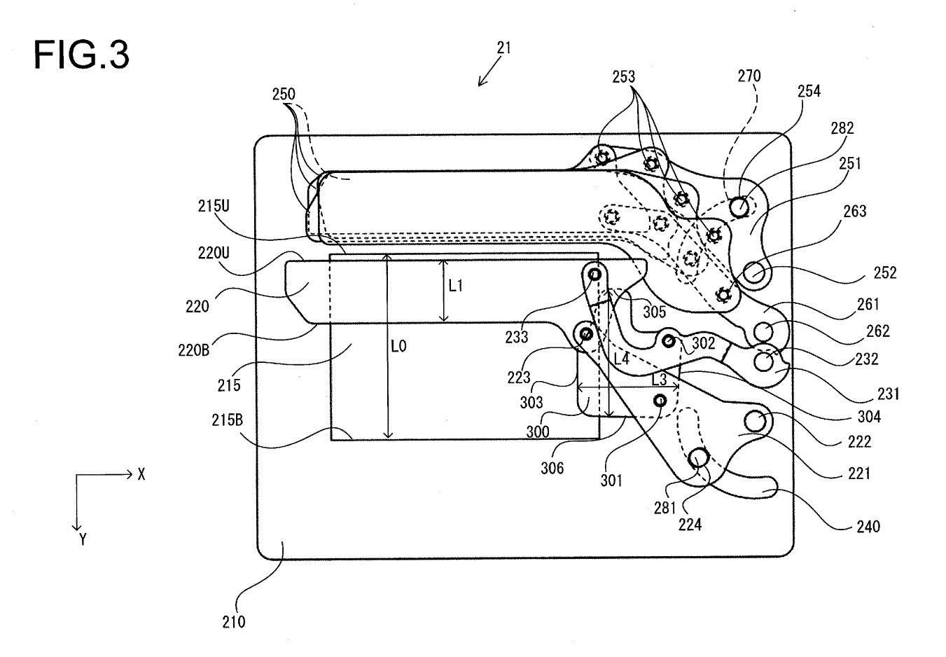

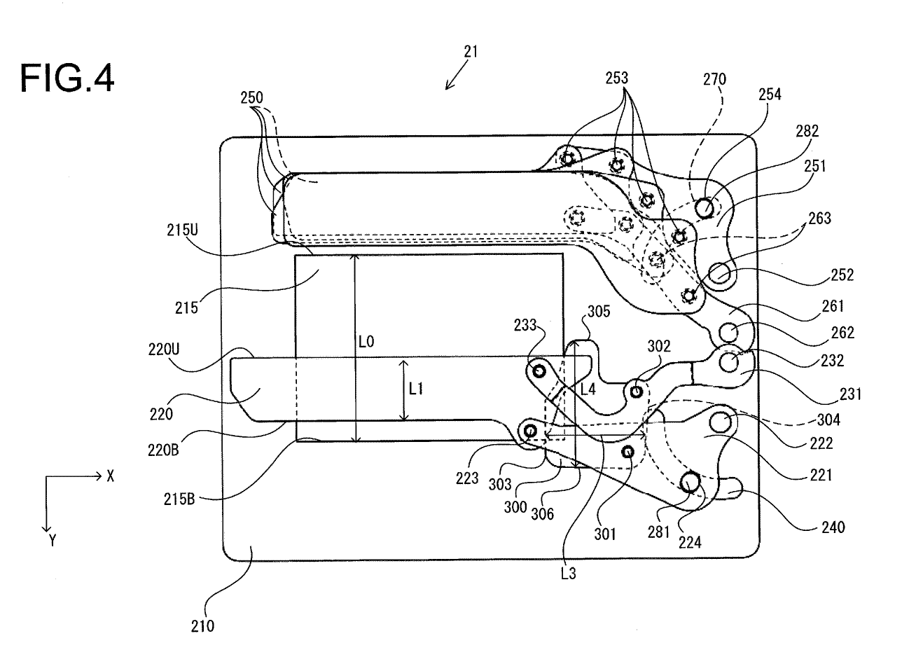

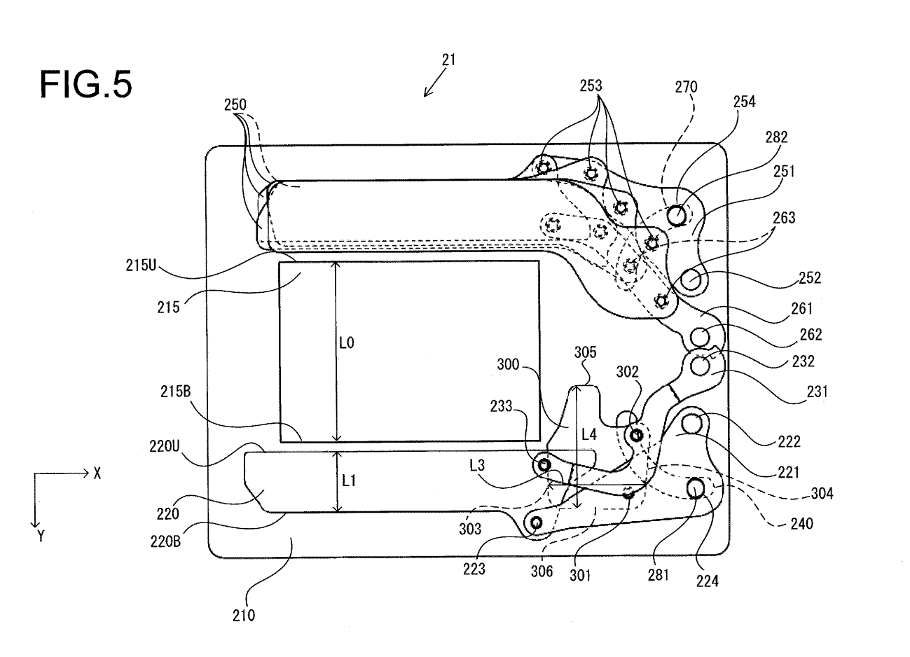

FIGS. 2 to 5 are views illustrating an internal configuration of the shutter device 21 as seen from the image sensor 22 side, that is, the rear side of the digital camera 1. For convenience of explanation, a coordinate system having the X axis and the Y axis will be defined as illustrated in the figures. FIG. 2 is a view illustrating a state of the shutter device 21 before a start of photographing is instructed by the user operating the release button. In FIG. 2, both a front curtain light-shielding blade 220 and a rear curtain light-shielding blade 250 described later have been withdrawn in a first withdrawn position 201 above (or on the negative Y axis side of) an opening 215. FIG. 3 illustrates a state of the shutter device 21 after the user operates the release button to instruct the start of photographing, where the front curtain light-shielding blade 220 has started moving downward (in the positive Y axis direction) to traverse the opening 215. In FIG. 3, however, the rear curtain light-shielding blade 250 has not yet started to move. FIG. 4 is a view illustrating a state of the shutter device 21 wherein the front curtain light-shielding blade 220 further moves in the positive Y axis direction from the state illustrated in FIG. 3 and the auxiliary light-shielding blade 300 is now moving across the opening 215 downward (in the positive Y axis direction), in coordination with the front curtain light-shielding blade 220. FIG. 5 is a view illustrating a state where the front curtain light-shielding blade 220 and the auxiliary light-shielding blade 300 have moved further downward (in the positive Y axis direction) from the state illustrated in FIG. 4 to withdraw into a second withdrawn position 202 below (or on the positive Y axis side of) the opening 215 and into a fourth withdrawn position 204 on the right side of (or on the positive X axis side of) the opening 215, respectively, while the rear curtain light-shielding blade 250 has not yet started to move.

The shutter device 21 includes the substrate 210, the front curtain light-shielding blade 220, the rear curtain light-shielding blade 250, the auxiliary light-shielding blade 300, a front curtain driving arm 221, a front curtain driven arm 231, a rear curtain driving arm 251, a rear curtain driven arm 261, the front curtain actuator (not shown), and the rear curtain actuator (not shown). In this embodiment, each of the front curtain actuator and the rear curtain actuator is made of an electric motor or the like.

The substrate 210 is fixed in the camera body 20 and has an opening 215 to expose the image sensor 22 with light flux from the subject. The opening 215 is formed into a rectangular shape having two sides extending in the X axis direction and two sides extending along the Y axis direction. In the following description, a side of the opening 215 on the negative Y axis side will be referred to as an upper end 215U, a side on the positive Y axis side will be referred to as a bottom end 215B, and the length in the Y axis direction between the upper end 215U and the bottom end 215B will be denoted by L0.

Rear Curtain

As illustrated in FIGS. 3 to 5, for example, the rear curtain driving arm 251 has a substrate-side coupling part 252 in one end. The rear curtain driving arm 251 is rotatably pivoted at the substrate-side coupling part 252 by the substrate 210 on the rear side (the image sensor 22 side) of the substrate 210. The rear curtain driven arm 261 has a substrate-side coupling part 262 in one end. The rear curtain driven arm 261 is rotatably pivoted at the substrate-side coupling part 262 by the substrate 210 on the rear side (the image sensor 22 side) of the substrate 210, on the positive Y axis side of (or below in the figures) the rear curtain driving arm 251. The rear curtain driving arm 251 has a light-shielding member-side coupling part 253 at the other end. A plurality of rear curtain light-shielding blades 250 are rotatably coupled to the rear curtain driving arm 251 at the light-shielding member-side coupling part 253 with a caulking pin. The rear curtain driven arm 261 has a light-shielding member-side coupling part 263 at the other end. A plurality of rear curtain light-shielding blades 250 are rotatably coupled to the rear curtain driven arm 261 at the light-shielding member-side coupling part 263 with a caulking pin. The rear curtain driving arm 251 and the rear curtain driven arm 261 constitute a known parallel link mechanism for moving the rear curtain light-shielding blade 250.

The rear curtain driving arm 251 and the rear curtain driven arm 261 are provided above (or on the negative Y axis side of) the front curtain driving arm 221 and the front curtain driven arm 231 in the figures. Specifically, the substrate-side coupling part 252 of the rear curtain driving arm 251 and the substrate-side coupling part 262 of the rear curtain driven arm 261 are coupled to the substrate 210 below (or on the negative Y axis side of) the substrate-side coupling part 222 of the front curtain driving arm 221 described later and the substrate-side coupling part 232 of the front curtain driven arm 231 described later.

The rear curtain light-shielding blade 250 is a light-shielding member constituted by a plurality of blades extending in the X axis direction, each blade being pivoted at its right end by the rear curtain driving arm 251 and the rear curtain driven arm 261 in the figures.

The rear curtain driving arm 251 has a hole 254, into which a rear curtain driving pin 282 penetrating through an arcuate elongated hole 270 of the substrate 210 is inserted from the depth side of the paper plane, that is, from the front side of the digital camera 1. The rear curtain driving pin 282 is driven by the rear curtain actuator (not shown). The rear curtain actuator is made of an electric motor, as described above. The rear curtain actuator is driven by a driving current or power supply from a power supply unit (not shown) of the controller 26. When the rear curtain driving pin 282 is driven along the elongated hole 270 by the rear curtain actuator, the rear curtain driving arm 251 and the rear curtain driven arm 261 rotate about the substrate-side coupling part 252 and the substrate-side coupling part 262, respectively.

When the rear curtain driving arm 251 is driven to rotate about the substrate-side coupling portion 252, the rear curtain light-shielding blade 250 is driven by the known parallel link mechanism constituted by the rear curtain driving arm 251, the rear curtain driven arm 261, and the rear curtain light-shielding blade 250 to move across the opening 215 of the substrate 210 in the Y axis direction. In this embodiment, the rear curtain light-shielding blade 250 can move to the first withdrawn position 201 outside the opening 215 and to a light-shielding position where the rear curtain light-shielding blade 250 entirely covers the opening 215. As illustrated in FIGS. 2 to 5, the plurality of blades of the rear curtain light-shielding blade 250 overlap one another in the first withdrawn position 201. Although not illustrated, the plurality of blades of the rear curtain light-shielding blade 250 are unfolded to shield the opening 215 in the light-shielding position.

Although this embodiment describes the rear curtain light-shielding blade 250 moving on the rear side (the image sensor 22 side) of the opening 215, a variation of the embodiment contemplates the rear curtain light-shielding blade 250 moving on the front side (the subject side) of the opening 215. Furthermore, although the rear curtain light-shielding blade 250 entirely shields the opening 215 in this embodiment, the rear curtain light-shielding blade 250 may partly shield the opening 215 in the same manner as the front curtain light-shielding blade 220 described later. In this case, the rear curtain light-shielding blade 250 may be made of a single blade or may be constituted by a plurality of blades so as to not entirely cover the opening 215.

Front Curtain

As well illustrated in FIG. 3, the front curtain driving arm 221 has a substrate-side coupling part 222 in one end. The front curtain driving arm 221 is rotatably pivoted at the substrate-side coupling part 222 by the substrate 210 on the rear side (the image sensor 22 side) of the substrate 210. The front curtain driven arm 231 has a substrate-side coupling part 232 in one end. The front curtain driven arm 231 is rotatably pivoted at the substrate-side coupling part 232 by the substrate 210 on the rear side (the image sensor 22 side) of the substrate 210, above (or on the negative Y axis side) the front curtain driving arm 221 in the figures. The front curtain driving arm 221 has a light-shielding part-side coupling part 223 at the other end. The front curtain light-shielding blade 220 is rotatably coupled to the front curtain driving arm 221 at the light-shielding member-side coupling part 223 with a caulking pin. The front curtain driven arm 231 has a light-shielding part-side coupling part 233 at the other end. The front curtain light-shielding blade 220 is rotatably coupled to the front curtain driven arm 231 at the light-shielding member-side coupling part 233 with a caulking pin. The front curtain driving arm 221 and the front curtain driven arm 231 constitute a known parallel link mechanism for moving the front curtain light-shielding blade 220.

As described above, the front curtain driving arm 221 and the front curtain driven arm 231 are provided below (or on the positive Y axis side of) the rear curtain driving arm 251 and the rear curtain driven arm 261 in the figures. Specifically, the substrate-side coupling part 222 of the front curtain driving arm 221 and the substrate-side coupling part 232 of the front curtain driven arm 231 are coupled to the substrate 210 below (or on the positive Y axis side of) the substrate-side coupling part 252 of the rear curtain driving arm 251 and the substrate-side coupling part 262 of the rear curtain driven arm 261 in the figures.

The front curtain light-shielding blade 220 is a light-shielding member that extends in the X axis direction and is pivoted at its right end by the front curtain driving arm 221 and the front curtain driven arm 231. In this embodiment, the front curtain light-shielding blade 220 is made of a single blade in the figures.

The front curtain driving arm 221 has a hole 224, into which a front curtain driving pin 281 penetrating through an elongated hole 240 of the substrate 210 is inserted from the depth side of the paper plane, that is, from the front side of the digital camera 1. The front curtain driving pin 281 is driven by the front curtain actuator (not shown). The front curtain actuator is driven by a driving current or power supply from a power supply unit (not shown) of the controller 26. When the front curtain driving pin 281 is driven along the elongated hole 240 by the front curtain actuator, the front curtain driving arm 221 and the front curtain driven arm 231 rotate about the substrate-side coupling part 222 and the substrate-side coupling part 232, respectively.

When the front curtain driving arm 221 is driven to rotate about the substrate-side coupling portion 222, the front curtain light-shielding blade 220 is driven by the known parallel link mechanism, which is constituted by the front curtain driving arm 221, the front curtain driven arm 231, and the front curtain light-shielding blade 220, to move across the opening 215 of the substrate 210 in the Y axis direction, as described above. In this embodiment, the front curtain light-shielding blade 220 can move between the first withdrawn position 201 outside the opening 215 and the second withdrawn position 202 outside the opening 215, the second withdrawn position 202 being opposite to the first withdrawn position 201. The front curtain light-shielding blade 220 has moved to the first withdrawn position 201 in FIG. 2 and in the second withdrawn position 202 in FIG. 5.

As described above, the front curtain light-shielding blade 220 is made of a single blade. The upper edge 220U (FIG. 3) which is a side extending in the X axis direction on the negative Y axis side of the front curtain light-shielding blade 220 has a length larger than the width of the opening 215 in the X axis direction. Furthermore, a length (a light-shielding width) L1 in the Y axis direction (a direction of movement of the front curtain light-shielding blade 220 and the rear curtain light-shielding blade 250) between the upper edge 220U of the front blade light-shielding blade 220 and a bottom edge 220B (FIG. 3), which is a side extending in the X axis direction on the positive Y axis side, is shorter (smaller) than the length L0 of the opening 215 in the Y axis direction. The front curtain light-shielding blade 220 can therefore only partly cover the opening 215, in terms of structure. In other words, the front curtain light-shielding blade 220 has a light-shielding range in its direction of movement that is smaller than the length of the opening 215 in the direction of movement, in terms of structure. Details of the light-shielding region of the front curtain light-shielding blade 220 will be described later.

The length L1 of the front curtain light-shielding blade 220 in the Y axis direction is determined so that no subject light flux from the subject is irradiated at least onto pixel rows that are being subjected to the pixel reset in the image sensor 22. The minimal possible length can be designed to be a pixel pitch by matching a speed of movement of the front curtain light-shielding blade 220 with a pixel reset speed determined by a time required for the image sensor 22 to reset pixels for each entire image row. The time for the pixel reset may usually be set as desired. For an actual movement of the front curtain light-shielding blade 220, however, it is difficult to perfectly match the speed of movement of the front curtain light-shielding blade 220 with the pixel rest speed. Also considering other error factors, the length L1 of the front curtain light-shielding blade 220 in the Y axis direction is determined so that the following inequality (1) is satisfied:

L0>L1≧ΔL11 (1)

where ΔL11 is a constant which is determined from experiments or the like as a margin for a manufacturing error of the front curtain light-shielding blade 220 or deformation during the movement of the front curtain light-shielding blade 220 due to a material strength thereof, a margin for preventing an influence of light passing around the ends in the Y axis direction of the front curtain light-shielding blade 220 onto the image sensor, and a margin of synchronous error between the pixel reset speed and the speed of movement of the front curtain light-shielding blade 220.

Although this embodiment describes the front curtain light-shielding blade 220 moving on the rear side (the image sensor 22 side) of the opening 215, a variation of the embodiment contemplates a front curtain light-shielding blade 220 moving on the front side (the subject side) of the opening 215. Furthermore, the front curtain light-shielding blade 220 is not limited to the configuration made of a single blade. Alternatively, the front curtain light-shielding blade 220 may be constituted by a plurality of blades and a light-shielding region formed by the plurality of blades may have a shorter (smaller) length in the Y axis direction than the length LO of the opening 215 in the Y axis direction so as to not entirely cover the opening 215.

The Light-Shielding Region of the Front Curtain Light-Shielding Blade

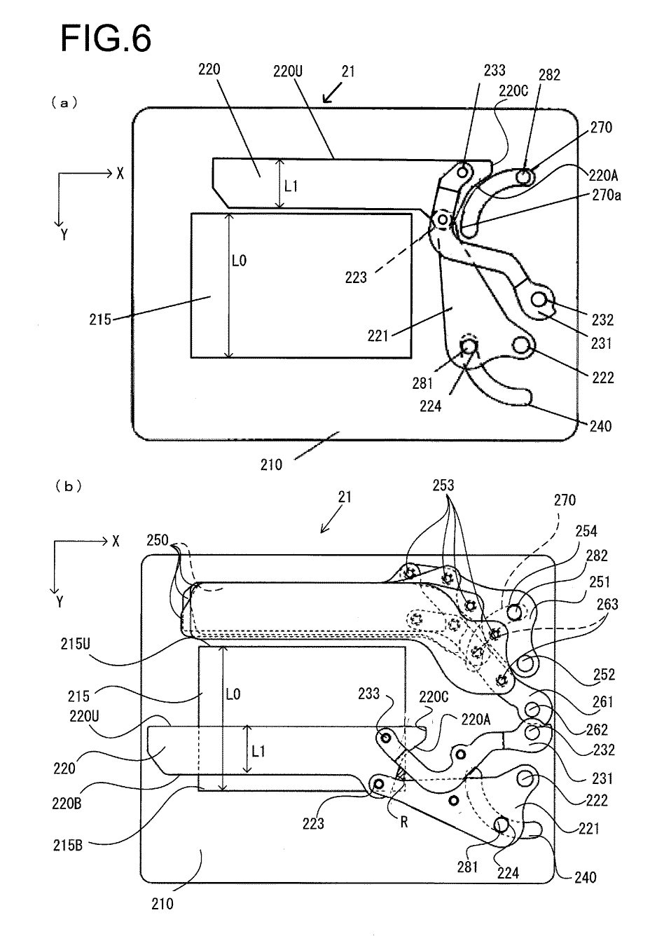

FIG. 6(a) illustrates a state where the front curtain light-shielding blade 220 is located in the first withdrawn position 201. FIG. 6(b) illustrates a state where the front curtain light-shielding blade 220 is moving across the opening 215. In FIG. 6(a), the rear curtain light-shielding blade 250, the rear curtain driving arm 251, and the rear curtain driven arm 261 are omitted for convenience of explanation. In FIGS. 6(a) and (b), an illustration of the auxiliary light-shielding blade 300 is omitted.

In this embodiment, a light-shielding region end on the positive X axis side (the right end side of the front curtain light-shielding blade) of the light-shielding region of the front curtain light-shielding blade 220 has an upper edge 220U, an arcuate edge 220A, and a side edge 220C connecting the upper edge 220U and the arcuate edge 220A, as illustrated in FIG. 6(a). The arcuate edge 220A is formed along an arc 270a of the arcuate elongated hole 270 and has a shape that is recessed in the negative X axis direction, on the positive Y axis side of the upper edge 220U. In other words, the arcuate edge 220A has a shape corresponding to the shape of the arcuate elongated hole 270. The side edge 220C extends from a positive X axis-side end point of the upper edge 220U in the positive Y axis direction to couple to the arcuate edge 220A. The light-shielding region end of the front curtain light-shielding blade 220 extends around the elongated hole 270 which is the movement range of the rear curtain driving pin 282. The length of the light-shielding region end on the positive X axis side of the front curtain light-shielding blade 220 in the positive Y axis direction from the upper edge 220U is thus smaller than L1.

As illustrated in FIG. 6(b), when the front curtain light-shielding blade 220 moves across the opening 215, the arcuate edge 220A also moves across the opening 215. As described above, the length of the light-shielding region end on the positive X axis side of the front curtain light-shielding blade 220 is smaller than L1 in the Y axis direction, since the arcuate edge 220A is provided in this light-shielding end. This makes it unable to shield a region R in the opening 215, which is denoted by hatching, below (or on the positive Y axis side of) the arcuate edge 220A of the front curtain light-shielding blade 220 when the front curtain light-shielding blade 220 moves across the opening 215. As described above, the length L1 of the front curtain light-shielding blade 220 is determined based on the time required for the pixel reset. Subject light that has passed through the region R can thus be incident onto the image sensor 22 during the pixel reset, which can cause an insufficient exposure. The shutter device 21 in this embodiment has the auxiliary light-shielding blade 300 to shield the region R.

Auxiliary Light-Shielding Blade

The auxiliary light-shielding blade 300 will be described with reference to FIGS. 2 to 5. The auxiliary light-shielding blade 300 is rotatably attached to an auxiliary light-shielding blade coupling part 301 in the middle of the substrate-side coupling part 222 and the light-shielding part-side coupling part 223 of the front curtain driving arm 221 and to an auxiliary light-shielding blade coupling part 302 in the middle of the substrate-side coupling part 232 and the light-shielding part-side coupling part 233 of the front curtain driven arm 231, to constitute a parallel link mechanism, together with the front curtain light-shielding blade 220.

The above-described configuration allows the front curtain driven arm 231 and the front curtain light-shielding blade 220 to move across the opening 215 in the positive Y axis direction in coordination with each other, when the front curtain driving arm 221 is driven to rotate about the substrate-side coupling part 222.

In this embodiment, the auxiliary light-shielding blade 300 can move across the opening 215 in the positive Y axis direction from a third withdrawn position 203 to a fourth withdrawn position 204. The third withdrawn position 203 is a position outside the opening 215 on the positive X axis side and on the upper side (or on the negative Y axis side). The fourth withdrawn position 204 is a position outside the opening 215 on the positive X axis side and on the lower side (or on the positive Y axis side). It should be noted that the auxiliary light-shielding blade 300 is located in the third withdrawn position 203 in FIG. 2 and in the fourth withdrawn position 204 in FIG. 5.

The auxiliary light-shielding blade 300 is made of a single blade. The blade constituting the auxiliary light-shielding blade 300 has a first edge 303 which is a side on the negative X axis side extending in the Y axis direction, a second edge 304 which is a side on the positive X axis side extending in the Y axis direction, a third edge 305 which is a side on the negative Y axis side, and a fourth edge 306 which is a side on the positive Y axis side extending in the X axis direction. A length L3 in the X axis direction between the first edge 303 and the second edge 304 is smaller than the length of the opening 215 in the X axis direction. A length L4 in the Y axis direction between the third edge 305 and the fourth edge 306 is smaller than the length of the opening 215 in the Y axis direction. In other words, the auxiliary light-shielding blade 300 can partly shield the opening 215. The auxiliary light-shielding blade 300 is coupled with the front curtain driving arm 221 and the front curtain driven arm 231 in the vicinity of the second edge 304. It should be noted that the first edge 303 of the auxiliary light-shielding blade 300 is located on the positive X axis side of the opening 215, when the auxiliary light-shielding blade 300 is located in the third withdrawn position 203.

The light-shielding region of the auxiliary light-shielding blade 300 shields a region of the opening 215 below (or on the positive Y axis side of) the light-shielding region end on the positive X axis side of the front curtain light-shielding blade 220 described above, while the auxiliary light-shielding blade 300 moves in the positive Y axis direction. As described above with reference to FIG. 6(b), the region R of the opening 215 that cannot be shielded by the front curtain light-shielding blade 220 is left below the light-shielding region end on the positive X axis side of the front curtain light-shielding blade 220. The region R is a region caused by the fact that the light-shielding region end of the front curtain light-shielding blade 220 is formed to extend around the movement range of the rear curtain driving pin 282 so that the length of the light-shielding region end in the Y axis direction is smaller than the length L1. The auxiliary light-shielding blade 300 shields the region R while moving across the opening 215 in the positive Y axis direction. In other words, the lengths L3 and L4 of the auxiliary light-shielding blade 300 are larger than the lengths of the region R in the X axis and Y axis directions, respectively.

Operation of the Shutter Device 21

The shutter device 21 configured as described above operates as follows. Before the user operates the release button, the front curtain light-shielding blade 220 and the rear curtain light-shielding blade 250 are located in the first withdrawn position 201 as illustrated in FIG. 2, while the auxiliary light-shielding blade 300 is located in the third withdrawn position 203. In this state, subject light having passed through the photographic lens 11 is incident onto the image sensor 22 through the opening 215. Image-capturing signals are repeatedly read out from the image sensor 22 and images (preview images) corresponding to the image-capturing signals are displayed on the rear side monitor 30. This process is referred to as a live view display.

When the user operates the release button, the power supply unit (not shown) of the controller 26 starts to supply an electric power to the front curtain actuator (not shown) for shifting the front curtain light-shielding blade 220. When being supplied with the electric power, the front curtain actuator rotates the front curtain driving pin 281 along the elongated hole 240 in the counterclockwise direction. As a result, the front curtain driving arm 221 is driven to rotate about the substrate-side coupling part 222 in a plane parallel to the XY plane. Accordingly, the front curtain light-shielding blade 220, the front curtain driven arm 231, and the auxiliary light-shielding blade 300 are driven in a linked manner so that the front curtain light-shielding blade 220 moves from the first withdrawn position 201 in the positive Y axis direction and the auxiliary light-shielding blade 300 moves from the third withdrawn position 203 in the counterclockwise direction. The front curtain light-shielding blade 220 starts to enter the opening 215 from the upper end 215U of the opening 215, and the auxiliary light-shielding blade 300 starts to enter the opening 215 from the positive X axis-side edge of the opening 215 (see FIG. 3).

When the front curtain driving arm 221 is further driven to rotate, the front curtain light-shielding blade 220 and the auxiliary light-shielding blade 300 move in the positive Y axis direction and also the front curtain driven arm 231 rotates (see FIG. 4). In this point in time, the light-shielding region end on the positive X axis side of the light-shielding region of the front curtain light-shielding blade 220 also moves across the opening 215. Since the light-shielding region on the positive X axis side of the front curtain light-shielding blade 220 has a smaller length in the Y axis direction than L1 as described above, the region R of the opening 215 that cannot be shielded by the front curtain light-shielding blade 220 is left below (or on the positive Y axis side of) the light-shielding region end. The auxiliary light-shielding blade 300 moves in the positive Y axis direction with shielding the region R. As described above, the auxiliary light-shielding blade 300 constitutes the parallel link mechanism, together with the front curtain light-shielding blade 220 as well as the front curtain driving arm 221 and the front curtain driven arm 231. The auxiliary light-shielding blade 300 thus moves in the Y axis direction with the first edge 303 of the auxiliary light-shielding blade 300 being oriented in the Y axis direction.

The bottom edge 220B of the front curtain light-shielding blade 220 and the negative X axis-side end of the auxiliary light-shielding blade 300 start to move across the opening 215 and start to shield the image-capturing plane of the image sensor 22 behind the shutter. The image sensor 22 resets stored charge for pixels in the shielded region. When the upper edge 220U of the front curtain light-shielding blade 220 passes through the region of the image sensor 22 that has been shielded by the front curtain light-shielding blade 220 as illustrated in FIGS. 3 and 4, an exposure is started in the image-capturing plane of the image sensor 22 to store electric charges for pixels included in the image-capturing region through which the upper edge 200U has passed.

The upper edge 220U of the front curtain light-shielding blade 220 moves in the positive Y axis direction beyond the bottom end 215B of the opening 215 so that the front curtain light-shielding blade 220 moves into the second withdrawn position 202 below the opening 215 (see FIG. 5). The auxiliary light-shielding blade 300 moves in a direction further away from the opening 215, along with the rotational movement of the front curtain driving arm 221, into the fourth withdrawn position 204 (see FIG. 5). When the front curtain light-shielding blade 220 moves to the second withdrawn position 202 and the auxiliary light-shielding blade 300 moves to the fourth withdrawn position 204, the pixel reset and the exposure (i.e., the charge storage) are performed for the entire image-capturing plane of the image sensor 22.

In this context, the controller 26 controls the timing of pixel reset for each of pixel rows extending in the X axis direction that constitute the image sensor 22, in accordance with the shift of the front curtain light-shielding blade 220 and the auxiliary light-shielding blade 300 in the positive Y axis direction. In other words, the controller 26 resets pixels for pixel rows included in a region that is shielded from light flux from the subject by the shift of the front curtain light-shielding blade 220 and the auxiliary light-shielding blade 300.

Once a time equivalent to the exposure time has elapsed since the front curtain light-shielding blade 220 started to move, the power control unit (not shown) of the controller 26 supplies an electric power to the rear curtain actuator (not shown) for moving the rear curtain light-shielding blade 250. When being supplied with the electric power, the rear curtain actuator rotates the rear curtain driving pin 282 along the elongated hole 270 in the counterclockwise direction. As a result, the rear curtain driving arm 251 is driven to rotate about the substrate-side coupling part 252 in a plane parallel to the XY plane so that the rear curtain light-shielding blade 250 moves from the withdrawn position above the opening 215 in the positive Y axis direction by the action of the parallel link mechanism constituted by the rear curtain driving arm 251 and the rear curtain driven arm 261.

In this way, the front curtain light-shielding blade 220 first starts to move in the positive Y axis direction and, after a time equivalent to the exposure time has elapsed, the rear curtain light-shielding blade 250 then starts to move in the positive Y axis direction. Consequently, subject light is incident onto the image sensor 22 after the reset, only during the exposure time, from a space between the upper edge 220U (FIG. 3) of the front curtain light-shielding blade 220 and the lower end of the lowermost blade of the rear curtain light-shielding blade 250. The image sensor 22 is exposed with the subject light.

Thereafter, the rear curtain light-shielding blade 250 moves to the light-shielding position where it entirely covers the opening 215.

The controller 26 controls the image sensor 22 to start to sequentially read pixels from the outermost pixel row on the negative Y axis side. Upon completion of reading the image-capturing signals from all the pixel rows, the controller 26 outputs driving signals from the power supply unit (not shown) to cause the front curtain light-shielding blade 220, the rear curtain light-shielding blade 250, and the auxiliary light-shielding blade 300 to be moved in the negative Y axis direction with the driving force of the electric motor (not shown). The front curtain light-shielding blade 220 and the rear curtain light-shielding blade 250 are stored in the first withdrawn position 201 above the opening 215, while the auxiliary light-shielding blade 300 is stored in the third withdrawn position 203. The operational control of the shutter device 21 during the exposure is then ended.

In this embodiment, the front curtain light-shielding blade 220 and the rear curtain light-shielding blade 250 are stored in the first withdrawn position 201 above the opening 215 until the exposure starts, as described above. In contrast to the case where the front curtain light-shielding blade 220 and the rear curtain light-shielding blade 250 are stored in positions that are opposite to each other with the opening 215 therebetween, it is thus not necessary to move the front curtain light-shielding blade 220 to a stored position at the start of the exposure. As a result, a release time lag is eliminated or minimized.

The embodiment described above provides the following operational advantages.

(1) In the shutter device 21, both the front curtain light-shielding blade 220 and the rear curtain light-shielding blade 250 are withdrawn to the other side in the photographing preparation state before the actual exposure. In the actual exposure, the front curtain light-shielding blade 220 is moved in the positive Y axis direction to reset pixels in a range of the image sensor 22 that is shielded by the front curtain light-shielding blade 220, and then the rear curtain light-shielding blade 250 is moved in the positive Y axis direction with a predetermined time difference with respect to the front curtain light-shielding blade 220 to end the exposure of the image sensor 22.

In the shutter device 21 configured so that both the front curtain light-shielding blade 220 and the rear curtain light-shielding blade 250 are stored in the first withdrawn position, the movement range of the front curtain light-shielding blade 220 is made wider than that of the known shutter device 21. This can cause the front curtain light-shielding blade 220 during its withdrawal movement to interfere with the rear curtain driving pin 282 driving the rear curtain light-shielding blade 250. In this case, if the front curtain light-shielding blade 220 is shaped to extend around the movement range of the rear curtain driving pin 282 in order to avoid to interfere with the rear curtain driving pin 282 during the withdrawal movement, the light-shielding region end of the front curtain light-shielding blade 220 can fail to shield the opening 215 while moving in the positive Y axis direction.

Thus, the shutter device 21 according to this embodiment includes the auxiliary light-shielding blade 300 that has a light-shielding region having lengths in the X axis and Y axis directions smaller than the those of the opening 215 and can move in the Y axis direction in coordination with the front curtain light-shielding blade 220. The auxiliary light-shielding blade 300 partly shields the opening 215 in the light-shielding region end of the front curtain light-shielding blade 220, while moving in the Y axis direction. The front curtain light-shielding blade 220 and the rear curtain light-shielding blade 250 can therefore be stored in the first withdrawn position 201 until the start of photographing. This can reduce the release time lag and also shield the opening 215 so that the reduced light-shielding region in the light-shielding region end on the positive X axis side of the front curtain light-shielding blade 220 is compensated for. In other words, leakage light in the light-shielding region end on the positive X axis side of the front curtain light-shielding blade 220 is prevented from being incident onto the image sensor 22 during the pixel reset, which can prevent the insufficient exposure.

Furthermore, the light-shielding region of the auxiliary light-shielding blade 300 has lengths in the X axis and Y axis directions smaller than those of the opening 215. In other words, the auxiliary light-shielding blade 300 has a smaller light-shielding region than that of the front curtain light-shielding blade 220. This minimizes an increase in mass caused by providing the auxiliary light-shielding blade 300, which contributes to a weight reduction. Additionally, a noticeable increase in power supplied to the front curtain actuator can be restrained.

(2) The auxiliary light-shielding blade 300 withdraws outside the opening 215 while the front curtain light-shielding blade 220 is stored in the position outside the opening 215 of the substrate 210. Furthermore, the auxiliary light-shielding blade 300 partly shields the opening 215 in the light-shielding region end on the positive X axis side of the front curtain light-shielding blade 220, along with the movement of the front curtain light-shielding blade 220 in the Y axis direction. This can thus prevent a deterioration in image quality of the photographed image due to an insufficient exposure.

(3) The auxiliary light-shielding blade 300 is coupled to the front curtain driving arm 221 and the front curtain driven arm 231 and moved in the Y axis direction by the front curtain driving arm 221 and the front curtain driven arm 231. It is thus not necessary to use special members for moving the auxiliary light-shielding blade 300, which prevents an increase in number of components and contributes to a reduction in weight of the shutter device 21. Furthermore, it is possible that the auxiliary light-shielding blade 300 can be moved in the Y axis direction in firm coordination with the front curtain light-shielding blade 220 and shield the region R, since the auxiliary light-shielding blade 300 moves in the Y axis direction along with the rotational movement of the front curtain driving arm 221 and the front curtain driven arm 231.

### Second Embodiment

A second embodiment according to the present invention will be described with reference to the drawings. In the following description, the same components as those in the first embodiment are denoted by the same reference symbols and only differences between the embodiments will be mainly described. Configurations and functions not particularly described are the same as those in the first embodiment. This embodiment differs from the first embodiment in that the auxiliary light-shielding blade is differently shaped and attached. Thus, the following description mainly refers to how the auxiliary light-shielding blade is shaped and attached.

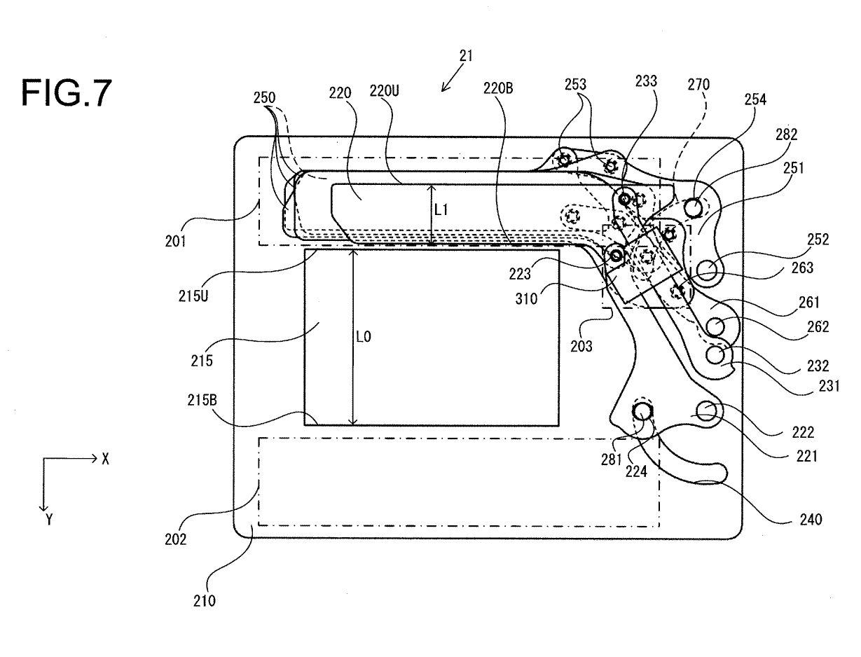

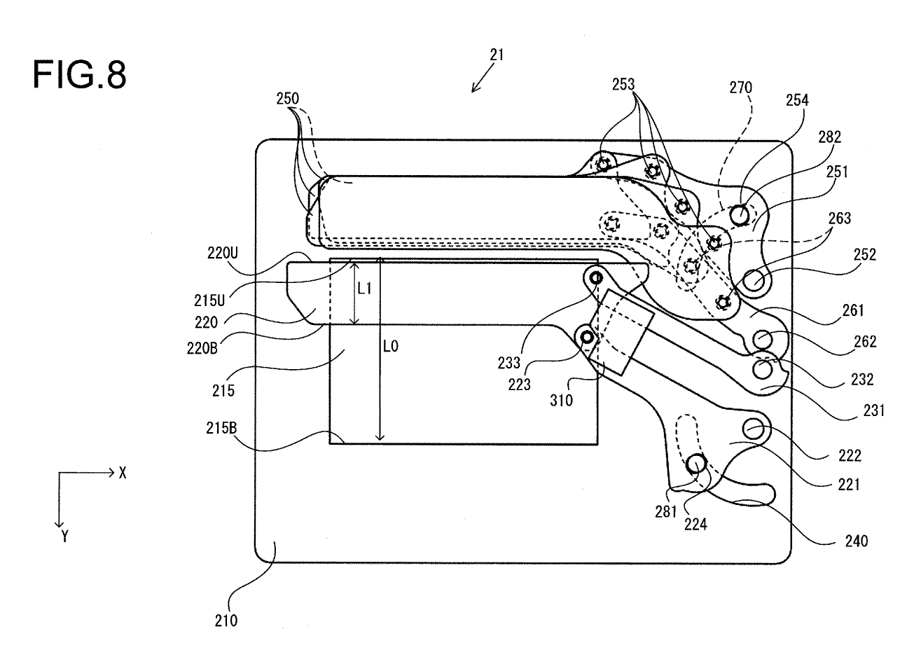

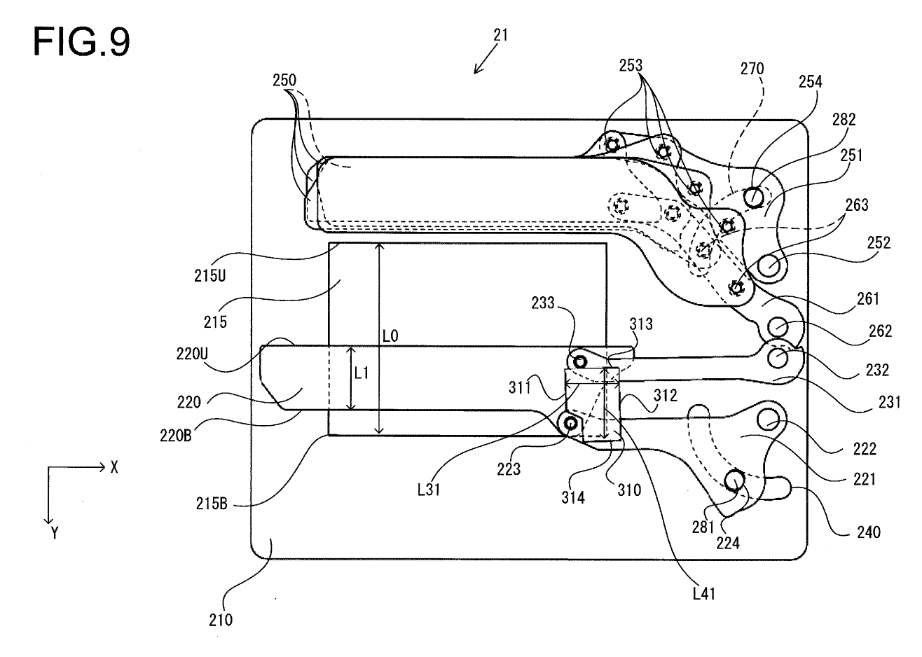

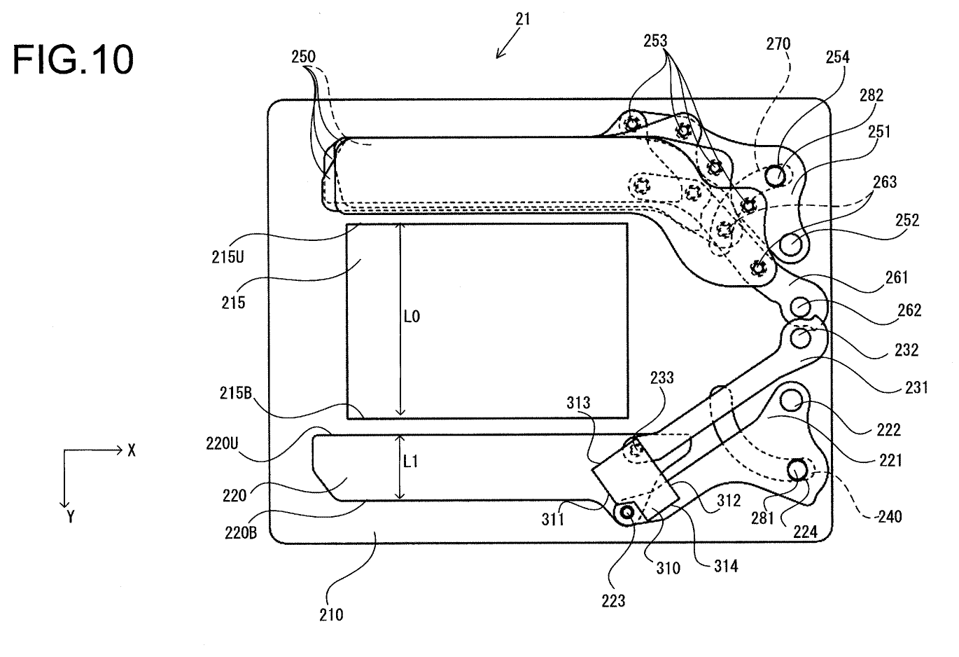

FIGS. 7 to 10 are views illustrating an internal configuration of the shutter device 21 according to the second embodiment as seen from the image sensor 22 side, that is, the rear side of the digital camera 1. For convenience of explanation, a coordinate system having the X axis and the Y axis will be defined as illustrated in the figures. FIG. 7 is a view illustrating a state of the shutter device 21 before a user operates the release button to instruct the start of photographing. In FIG. 7, the front curtain light-shielding blade 220 and the rear curtain light-shielding blade 250 are withdrawn in the first withdrawn position 201, while the auxiliary light-shielding blade 310 is withdrawn in the third withdrawn position 203. FIG. 8 illustrates a state of the shutter device 21 after the user operates the release button to instruct the start of photographing, where the front curtain light-shielding blade 220 has started moving downward (in the positive Y axis direction) to traverse the opening 215. It should be noted that the rear curtain light-shielding blade 250 has not yet started to move in FIG. 8. FIG. 9 is a view illustrating a state of the shutter device 21 wherein the front curtain light-shielding blade 220 further moves in the negative Y axis direction from the state illustrated in FIG. 8 and the auxiliary light-shielding blade 310 is now moving across the opening 215 downward (in the positive Y axis direction), in coordination with the front curtain light-shielding blade 220. FIG. 10 is a view illustrating a state where the front curtain light-shielding blade 220 and the auxiliary light-shielding blade 300 have moved further downward (in the positive Y axis direction) from the state illustrated in FIG. 9 to withdraw into a second withdrawn position 202 below (or on the positive Y axis side of) the opening 215, while the rear curtain light-shielding blade 250 has not yet started to move.

The auxiliary light-shielding blade 310 is fixed in the vicinity of the light-shielding part-side coupling part 223 of the front curtain driving arm 221 and moves together along with the rotational movement of the front curtain driving arm 221. When the front curtain light-shielding blade 220 is driven by the known parallel link mechanism constituted by the front curtain driving arm 221 and the front curtain driven arm 231, the auxiliary light-shielding blade 310 moves across the opening 215 in the positive Y axis direction in coordination with the movement of the front curtain light-shielding blade 220.

It should be noted that the front curtain driving arm 221 does not include the auxiliary light-shielding blade coupling part 301 and also the front curtain driven arm 231 does not include the auxiliary light-shielding blade coupling part 302 in this embodiment, since the auxiliary light-shielding blade 310 is fixed to the front curtain driving arm 221.

In this embodiment, the auxiliary light-shielding blade 310 starts to enter the opening 215 from the positive X axis-side edge of the opening 215 and can move across the opening 215 in the positive Y axis direction to the second withdrawn position 202. It should be noted that the auxiliary light-shielding blade 310 is located in the third withdrawn position 203 in FIG. 7 and in the second withdrawn position 202 in FIG. 10.

The auxiliary light-shielding blade 310 is made of a single planar blade. The blade constituting the auxiliary light-shielding blade 300 has a first edge 311, a second edge 312, a third edge 313, and a fourth edge 314. The first edge 311 is a side extending in the Y axis direction on the negative X axis side while the auxiliary light-shielding blade 310 moves in the Y axis direction (see FIG. 9). The second edge 312 is a side extending in the Y axis direction on the positive X axis side while the auxiliary light-shielding blade 310 moves in the Y axis direction (see FIG. 9). The third edge 313 is a side extending in the X axis direction on the negative Y axis side while the auxiliary light-shielding blade 310 moves in the Y axis direction (see FIG. 9). The fourth edge 314 is a side extending in the X axis direction on the positive Y axis side while the auxiliary light-shielding blade 310 moves in the Y axis direction (see FIG. 9).

A length L31 in the X axis direction between the first edge 311 and the second edge 314 is smaller than the length of the opening 215 in the X axis direction (see FIG. 9). A length L41 in the Y axis direction between the third edge 315 and the fourth edge 316 is larger than a spacing between the front curtain driving arm 221 and the front curtain driven arm 231 during the rotational movement and smaller than the length of the opening 215 in the Y axis direction (see FIG. 9). The auxiliary light-shielding blade 310 can thus partly shield the opening 215. The light-shielding region of the auxiliary light-shielding blade 310 shields a region R of the opening 215 that is left in the light-shielding region end on the positive X axis side of the front curtain light-shielding blade 220 described above, while the auxiliary light-shielding blade 310 moves in the positive Y axis direction (see FIG. 9). In other words, the lengths L3 and L4 of the auxiliary light-shielding blade 310 are larger than the lengths of the region R in the X axis and Y axis directions, respectively.

When the shutter device 21 starts to operate, the auxiliary light-shielding blade 310 starts to move from the third withdrawn position 203 (see FIG. 7) and enter the opening 215 from the positive X axis-side edge of the opening 215 (see FIG. 8). In accordance with the rotational movement of the front curtain driving arm 221 and the front curtain driven arm 231, the front curtain light-shielding blade 220 and the auxiliary light-shielding blade 310 move in the positive Y axis direction (see FIG. 9). The auxiliary light-shielding blade 310 moves in the positive Y axis direction to shield the region R. Eventually, the front curtain light-shielding blade 220 and the auxiliary light-shielding blade 310 move to the second withdrawn position 202 below the opening 215 (see FIG. 10).

The second embodiment described above provides the same operational advantages as the operational advantages (1) to (3) achieved by the first embodiment.

Additionally, the auxiliary light-shielding blade 310 is fixed in the vicinity of the light-shielding part-side coupling part 223 of the front curtain driving arm 221. In comparison to the case where the auxiliary light-shielding blade 310 is rotatably coupled to the front curtain driving arm 221 and the front curtain driven arm 231, the auxiliary light-shielding blade 310 is easy to attach, which contributes to an improvement in productivity.

Although the auxiliary light-shielding blade 310 and the front curtain driving arm 221 are separate members, a region of the auxiliary light-shielding blade 310 may be integrally formed with the front curtain driving arm 221.

### Third Embodiment

A third embodiment according to the present invention will be described with reference to the drawings. In the following description, the same components as those in the first embodiment are denoted by the same reference symbols and only differences between the embodiments will be mainly described. Configurations not specifically described are the same as those in the first embodiment. This embodiment differs from the first embodiment in that the auxiliary light-shielding blade is differently shaped and attached. Thus, the following description mainly refers to how the auxiliary light-shielding blade is shaped and attached.

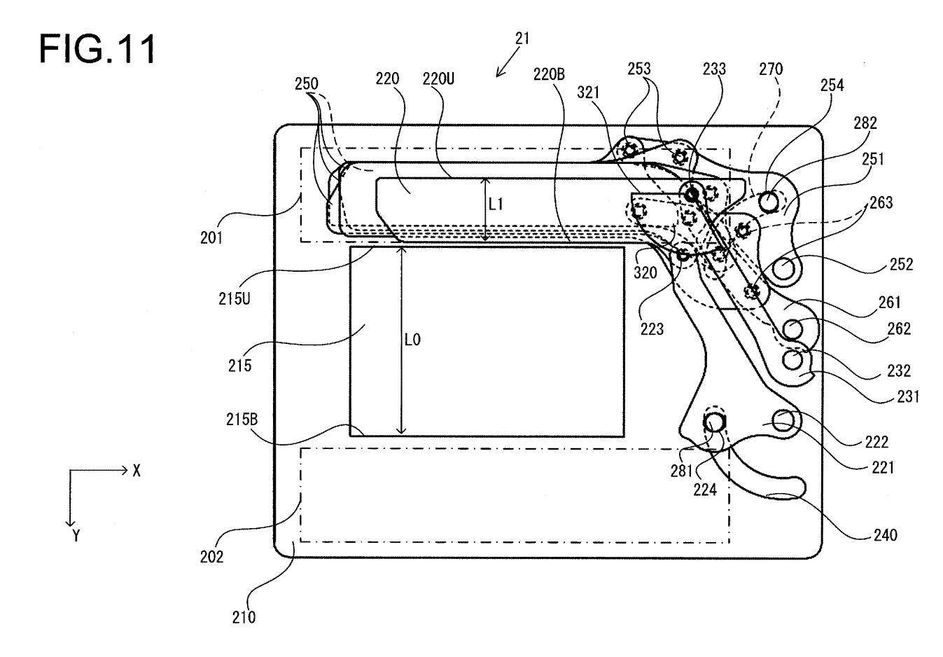

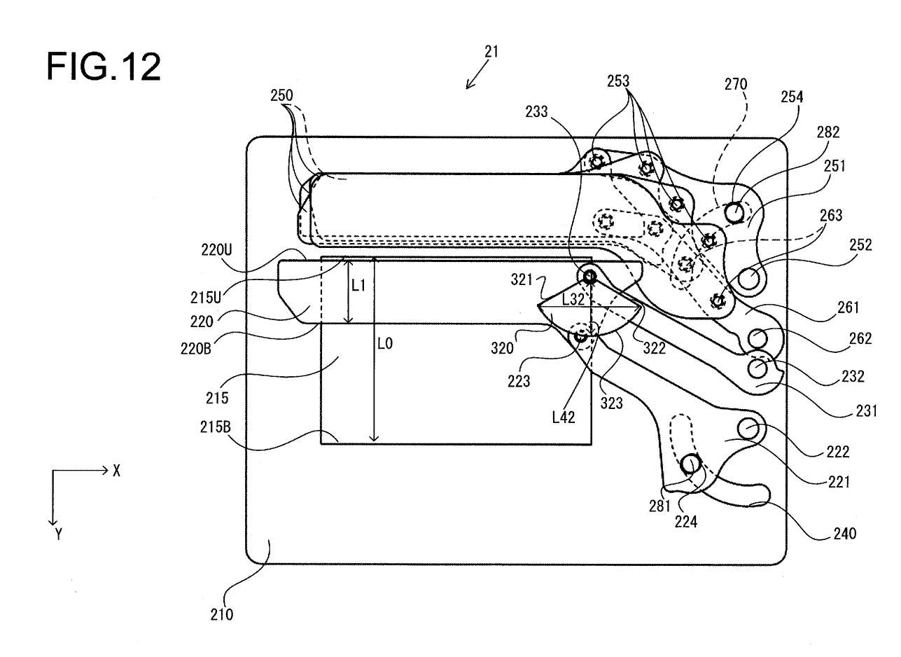

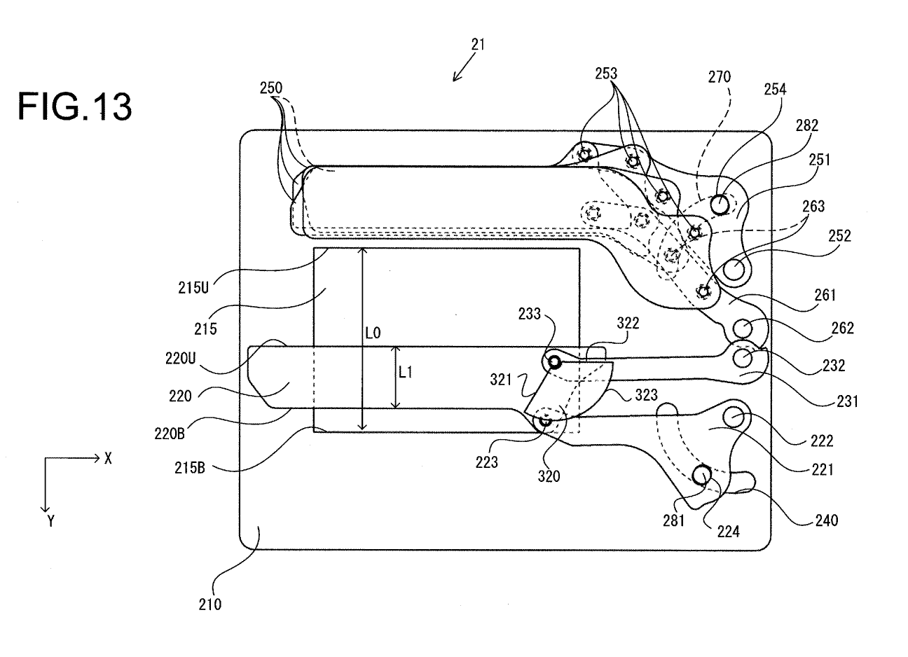

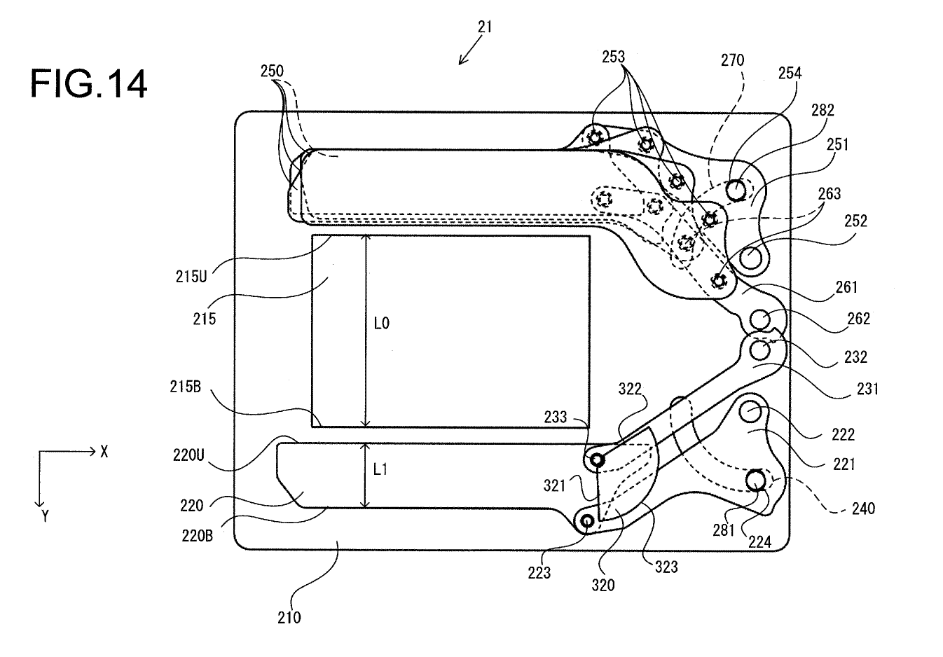

FIGS. 11 to 14 are views illustrating an internal configuration of the shutter device 21 according to the third embodiment as seen from the image sensor 22 side, that is, the rear side of the digital camera 1. For convenience of explanation, a coordinate system having the X axis and the Y axis will be defined as illustrated in the figures. FIG. 11 is a view illustrating a state of the shutter device 21 before the user operates the release button to instruct the start of photographing. In FIG. 11, the front curtain light-shielding blade 220, the rear curtain light-shielding blade 250, and the auxiliary light-shielding blade 320 are withdrawn in the first withdrawn position 201. FIG. 12 illustrates a state of the shutter device 21 after the user operates the release button to instruct the start of photographing, where the front curtain light-shielding blade 220 has started moving downward (in the positive Y axis direction) to traverse the opening 215. In FIG. 12, however, the rear curtain light-shielding blade 250 has not yet started to move. FIG. 13 is a view illustrating a state of the shutter device 21 wherein the front curtain light-shielding blade 220 further moves in the positive Y axis direction from the state illustrated in FIG. 12 and the auxiliary light-shielding blade 320 is now moving across the opening 215 downward (in the positive Y axis direction), in coordination with the front curtain light-shielding blade 220. FIG. 14 is a view illustrating a state where the front curtain light-shielding blade 220 and the auxiliary light-shielding blade 310 have moved further downward (in the positive Y axis direction) from the state illustrated in FIG. 13 to withdraw into a second withdrawn position 202 below (or on the positive Y axis side of) the opening 215, while the rear curtain light-shielding blade 250 has not yet started to move.

The auxiliary light-shielding blade 320 is fixed in the vicinity of the light-shielding part-side coupling part 233 of the front curtain driven arm 231 and moves together along with the rotational movement of the front curtain driven arm 231. When the front curtain light-shielding blade 220 is driven by the known parallel link mechanism constituted by the front curtain driving arm 221 and the front curtain driven arm 231, the auxiliary light-shielding blade 320 moves across the opening 215 in the positive Y axis direction in coordination with the movement of the front curtain light-shielding blade 220.

It should be noted that the front curtain driving arm 221 does not include the auxiliary light-shielding blade coupling part 301 and also the front curtain driven arm 231 does not include the auxiliary light-shielding blade coupling part 302 in this embodiment, since the auxiliary light-shielding blade 320 is fixed on the front curtain driven arm 231.

In this embodiment, the auxiliary light-shielding blade 320 starts to enter the opening 215 from the first withdrawn position 201 to the upper end 215U of the opening 215 and can move across the opening 215 in the positive Y axis direction to the second withdrawn position 202. It should be noted that the auxiliary light-shielding blade 320 is located in the first withdrawn position 201 in FIG. 11 and in the second withdrawn position 202 in FIG. 14.

The auxiliary light-shielding blade 320 is made of a single planar blade. The blade constituting the auxiliary light-shielding blade 300 has a first edge 321, a second edge 322, and a third edge 323 so that the light-shielding region is formed into a sector shape. The first edge 321 is a side extending in the X axis direction when the auxiliary light-shielding blade 320 is located in the first withdrawn position 201 (see FIG. 11). The second edge 322 is a side extending in the same direction as that the front curtain driven arm 231 extends (see FIGS. 11 to 14). The auxiliary light-shielding blade 320 is fixed to the front curtain driven arm 231 in the vicinity of the second edge 322. The third edge 323 is formed into an arcuate shape connecting the first edge 321 and the second edge 322 (see FIGS. 11 to 14). The first edge 321 and the second edge 322 have the substantially same length since the auxiliary light-shielding blade 320 has a sector shape as described above.

A length L32 between a connecting point of the first edge 321 and the third edge 323 and a connecting point of the second edge 322 and the third edge 323 is smaller than the length of the opening 215 in the X axis direction (see FIG. 12). A length L42 of the first edge 321 or the second edge 322, that is, a diameter of the sector forming the light-shielding region of the auxiliary light-shielding blade 320 is smaller than the length L0 of the opening 215 (see FIG. 12). The auxiliary light-shielding blade 310 can thus partly shield the opening 215. The light-shielding region of the auxiliary light-shielding blade 320 shields the region R in the light-shielding region end on the positive X axis side of the front curtain light-shielding blade 220 described above, while the auxiliary light-shielding blade 320 moves in the positive Y axis direction (see FIG. 13). In other words, the lengths L32 and L42 of the auxiliary light-shielding blade 320 are larger than the lengths of the region R in the X axis and Y axis directions, respectively.

When the shutter device 21 starts to operate, the auxiliary light-shielding blade 320 starts to move together with the front curtain light-shielding blade 220 from the first withdrawn position 201 (see FIG. 11) and enter the opening 215 from the upper edge 220U of the opening 215 (see FIG. 12). In accordance with the rotational movement of the front curtain driving arm 221 and the front curtain driven arm 231, the front curtain light-shielding blade 220 and the auxiliary light-shielding blade 320 move in the positive Y axis direction (see FIG. 13). The auxiliary light-shielding blade 320 then moves in the positive Y axis direction with shielding the region R. Eventually, the front curtain light-shielding blade 220 and the auxiliary light-shielding blade 320 move to the second withdrawn position 202 below the opening 215 (see FIG. 14).

The third embodiment described above provides the same operational advantages as the operational advantages (1) to (3) achieved by the first embodiment.

Additionally, since the auxiliary light-shielding blade 320 is fixed in the vicinity of the light-shielding part-side coupling part 223 of the front curtain driven arm 231, the auxiliary light-shielding blade 320 is easy to attach, which contributes to an improvement in productivity as in the case of the second embodiment.

Although the auxiliary light-shielding blade 320 and the front curtain driven arm 231 are separate members, a region of the auxiliary light-shielding blade 320 may be integrally formed with the front curtain driven arm 231.

Variations

Instead of coupling or fixing the front curtain driving arm 221 and/or the front curtain driven arm 231 to the auxiliary light-shielding blade as in the shutter device 21 according to the first to third embodiments described above, the shutter device 21 may include a special auxiliary light-shielding blade driving arm for driving an auxiliary light-shielding blade. In this case, the auxiliary light-shielding blade driving arm has a substrate-side coupling part on one end and an auxiliary light-shielding blade coupling part on the other end. The auxiliary light-shielding blade driving arm is rotatably pivoted at the substrate-side coupling part by the substrate 210 on the rear side (the image sensor 22 side) of the substrate 210. The auxiliary light-shielding blade is rotatably coupled to the auxiliary light-shielding blade driving arm at the auxiliary light-shielding blade coupling part with a caulking pin.

The auxiliary light-shielding blade driving arm has a coupling part which is a planar member, for example. The auxiliary light-shielding blade driving arm is coupled to the front curtain driving arm 221 with this coupling part. When the front curtain driving arm 221 is driven to rotate about the substrate-side coupling part 222 as described above, the auxiliary light-shielding blade driving arm, which is coupled to the front curtain driving arm 221 via the coupling part, is also driven to rotate about the substrate-side coupling part. Consequently, the auxiliary light-shielding blade moves in the Y axis direction, in coordination with the front curtain light-shielding blade 220 which moves in the Y axis direction along with the rotational movement of the front curtain driving arm 221.

The auxiliary light-shielding blade driving arm may not be coupled to the front curtain driving arm 221 with the coupling part. In this case, the auxiliary light-shielding blade driving arm is configured to be driven to rotate about the substrate-side coupling part by the auxiliary light-shielding blade actuator which is constituted by an electric motor or the like. The power supply unit of the controller 26 controls a timing at which the front curtain actuator is supplied with an electric power and a timing at which the auxiliary light-shielding blade actuator is supplied with an electric power. The auxiliary light-shielding blade thus can move in the Y axis direction to shield the region R while the front curtain light-shielding blade 220 moves in the Y axis direction. Consequently, the auxiliary light-shielding blade moves in the Y axis direction in coordination with the movement of the front curtain light-shielding blade 220.

In the above description, the front curtain actuator is made of an electric motor or the like. Alternatively, the front curtain actuator may be configured to shift the front curtain light-shielding blade 220 toward the second withdrawn position 202 by a biasing force of a spring and to urge the front curtain light-shielding blade 220 into the first withdrawn position 201 by a power of the electric motor. The same also applies to the rear curtain actuator. Furthermore, the front curtain actuator may be made of an electric motor or the like, while the rear curtain actuator may be constituted by a spring and an electric motor. Still further, the front curtain actuator may be constituted by a spring and an electric motor, while the rear curtain actuator may be made of an electric motor or the like.

The above-described embodiments and variations may be combined.

The present invention is not limited to the embodiments described above and other embodiments that are conceivable within the technical idea of the present invention are also included within the scope of the present invention, as long as they do not impair the features of the present invention.

The disclosure of the following priority application is herein incorporated by reference:

Japanese Patent Application No. 2014-223429 (filed Oct. 31, 2014)

### REFERENCE SIGNS LIST

1 . . . digital camera, 21 . . . shutter device, 22 . . . image sensor, 201 . . . first withdrawn position, 202 . . . second withdrawn position, 203 . . . third withdrawn position, 204 . . . fourth withdrawn position, 210 . . . substrate, 215 . . . opening, 220 . . . front curtain light-shielding blade, 221 . . . front curtain driving arm, 222 . . . substrate-side coupling part, 223 . . . light-shielding member-side coupling part, 231 . . . front curtain driven arm, 232 . . . substrate-side coupling part, 233 . . . light-shielding member-side coupling part, 240, 270 . . . elongated hole, 250 . . . rear curtain light-shielding blade, 251 . . . rear curtain driving arm, 261 . . . rear curtain driven arm, 281 . . . front curtain driving pin, 282 . . . rear curtain driving pin, 300, 310, 320 . . . auxiliary light-shielding blade

1. A shutter device, comprising:
a substrate having an opening;
a first light-shielding member that has a light-shielding region having a length in a first direction larger than a length of the opening in the first direction and a length in a second direction smaller than a length of the opening in the second direction, and partly shields the opening while moving from a first position outside the opening of the substrate to a second position outside the opening, the second position being different from the first position; and
a second light-shielding member that has a light-shielding region having a length in the first direction smaller than the length of the opening in the first direction and a length in the second direction smaller than the length of the opening in the second direction, and shields the opening between an end in the first direction of the first light-shielding member and the substrate while moving in the second direction.

2. The shutter device according to claim 1, wherein:
the second light-shielding member is located outside the opening while the first light-shielding member is located in the first position, and the second light-shielding member partly shield the opening in the end in the first direction of the light-shielding region along with the movement of the first light-shielding member in the second direction.

3. The shutter device according to claim 1, further comprising:
a first driving member that is provided for the first light-shielding member and drives the first light-shielding member in the second direction, wherein:
the second light-shielding member is driven in the second direction by the first driving member.

4. The shutter device according to claim 1, further comprising:
a third light-shielding member that moves from the first position in the second direction to shield the opening; and
a second driving member that moves the third light-shielding member.

5. The shutter device according to claim 4, wherein:
the end in the first direction of the light-shielding region of the first light-shielding member has a shape that extends around the movement range of the second driving member.

6. The shutter device according to claim 1, wherein:
the first light-shielding member and the second light-shielding member move to different positions outside the opening of the substrate.

7. An image-capturing apparatus, comprising:
the shutter device according to claim 1; and
an image sensor that receives luminous flux from a subject through the shutter device.
